(19) United States
(12) Patent Application Publication
(10) Pub. No.: US 2017/0205134 A1
(43) Pub. Date: Jul. 20, 2017

(54) HOUSEHOLD APPLIANCE, IN PARTICULAR HOUSEHOLD REFRIGERATION APPLIANCE

(71) Applicant: BSH HAUSGERAETE GMBH, MUNICH (DE)

(72) Inventors: BERND OSBAR, AALEN (DE); GERALD SCHMIDT, GERSTETTEN (DE)

(21) Appl. No.: 15/326,826

(22) PCT Filed: Jun. 22, 2015
(86) PCT No.: PCT/EP2015/063978

§ 371 Date: Jan. 17, 2017

(30) Foreign Application Priority Data
Jul. 17, 2014 (DE) 10 2014 213 912.0

(51) Int. Cl. F25D 23/02; F25D 11/00; G07C 9/00; E05B 65/00; E05B 47/00; F25D 29/00; F25D 25/02

(52) U.S. Cl. CPC F25D 23/028; F25D 29/00; F25D 11/00; F25D 25/025; F25D 23/025; E05B 65/0042; E05B 47/0001; G07C 9/00174; F25D 2700/02; F25D 2700/08; E05B 2047/0094; E05B 2047/0068; G07C 2009/00769

(57) ABSTRACT

A household appliance includes a base body having an interior compartment, a door leaf pivotable relative to the base body for opening and closing the interior compartment and a closing device having an actuator. The actuator is constructed to move the closing device back and forth between a position latching the closed door leaf and a position unlatching the closed door leaf. The closing device has an RFID scanner and the household appliance is constructed to control the actuator, based on a code which is stored in an RFID transponder, is read by the RFID scanner and is associated with the closing device, in such a way that, depending on the position of the closing device before reading the code, the actuator moves the closing device from the latched position into the unlatched position or from the unlatched position into the latched position.

The invention relates to a domestic appliance, in particular a domestic refrigeration appliance. The domestic appliance comprises a base body with an interior compartment and a door leaf, which is arranged to pivot in relation to the base body, or a drawer, which can be at least partly pulled out of the interior compartment and pushed into the interior compartment. Further, the domestic appliance comprises a closing device for latching shut the closed door leaf or the closed drawer.

DE 10 2009 028 777 A1 discloses a refrigeration appliance that in particular takes the form of a wine storage cabinet and has a refrigeration compartment that can be closed by means of a device door. The refrigeration appliance comprises a closing unit by means of which the device door may be locked and unlocked when it is in its closed position. The closing unit may be locked and unlocked by means of remote control.

The object of the present invention is to provide an improved domestic appliance that has a door leaf or a drawer, and a closing device for latching shut the closed door leaf or the closed drawer.

The object of the invention is achieved by a domestic appliance that has a base body with an interior compartment, a door leaf, which is arranged to pivot in relation to the base body, for opening and closing the interior compartment, and a closing device having an actuator that is set up to move the closing device to and fro between a position in which the closed door leaf is latched shut and a position in which the closed door leaf is unlatched, wherein the closing device has an RFID scanner, and the domestic appliance is set up, on the basis of a code that is stored in an RFID transponder and read by means of the RFID scanner and associated with the closing device, to trigger the actuator such that, depending on the position of the closing device before the code is read, the actuator moves the closing device from its latched-shut position into its unlatched position or from its unlatched position into its latched-shut position.

The object of the invention is also achieved by a domestic appliance that has a base body with an interior compartment, a drawer, which can be at least partly pulled out of the interior compartment and pushed into the interior compartment, and a closing device having an actuator that is set up to move the closing device to and fro between a position in which the closed drawer is latched shut and a position in which the closed drawer is unlatched, wherein the closing device has an RFID scanner, and the domestic appliance is set up, on the basis of a code that is stored in an RFID transponder and read by means of the RFID scanner and associated with the closing device, to trigger the actuator such that, depending on the position of the closing device before the code is read, the actuator moves the closing device from its latched-shut position into its unlatched position or from its unlatched position into its latched-shut position.

The domestic appliance according to the invention accordingly comprises the base body with the interior compartment that can be closed by means of the door leaf or out of which the drawer can be at least partly pulled. The door leaf is for example pivotally secured to the base body by means of a hinge. When the drawer is pushed into the interior compartment, the drawer is closed.

According to a preferred embodiment, the domestic appliance according to the invention is a domestic refrigeration appliance whereof the base body takes the form of a thermally insulated housing and which has a refrigeration device for cooling the interior compartment. The interior compartment is then provided in particular for storing comestibles. Preferably, the interior compartment of the domestic refrigeration appliance is provided for storing wine and/or non-food comestible items such as tobacco or tobacco products.

It is also possible for the domestic appliance according to the invention to have both a door leaf and a drawer, and to have a respective closing device with an RFID scanner for the door leaf and for the drawer.

It is also possible for at least one drawer to be provided inside the interior compartment of the domestic appliance, or at least one further door leaf, which is provided for example to close part of the interior compartment, that is to say this drawer or the further door leaf is/are only accessible when the door leaf is open. This drawer or this further door leaf may likewise be provided with a corresponding closing device. If this drawer or the further door leaf are likewise to be closeable with their own closing device, it is preferably provided for actuation of the closing device for the further door leaf or the drawer that is inside the interior compartment to be initiated by means of a further RFID transponder whereof the code is associated with this closing device and differs from the code of the RFID transponder for the closing device of the door leaf.

The domestic appliance according to the invention further comprises the closing device by means of which the closed door leaf or the closed drawer can be latched shut. The closing device comprises the actuator, which moves the closing device to and fro between a position in which the closed door leaf or the closed drawer is latched shut and a position in which the closed door leaf or the closed drawer is unlatched, that is to say by means of which the closing device is able to unlatch and latch shut the closed door leaf or the closed drawer. For this purpose, the closing device comprises for example a closing member that may be moved by means of the actuator and can be moved to and fro between a first position, associated with the latched-shut position of the closing device, and a second position, associated with the unlatched position of the closing device. The closing member is secured for example to the base body and cooperates in its first position for example with a counter-closing member that is secured to the door leaf or to the drawer. It is also possible for the closing member to be secured to the door leaf or to the drawer and the counter-closing member to the base body.

After the closing device has been moved into the unlatched or latched-shut position, the closing device preferably remains in this position.

The counter-closing member is for example a hook into which the actuator moves the closing member in the second position by a linear movement or by a pivotal movement from the second position into the first position, such that the closing member is in operative connection with the hook and thus prevents the closed door leaf from being opened, or the closed drawer from being opened.

It is also possible to use as the counter-closing member a bolt, which in the closed condition of the door leaf or the drawer protrudes for example into an opening in the housing or an opening in a component secured to the housing. The bolt may have a groove into which a closing member is bolted by a shear movement.

The actuator is preferably operated by electrical power and is preferably constructed such that the closing device remains in its present position if the actuator is not supplied with electrical power, for example because of a power failure.

The actuator is for example an electric motor, a solenoid or a wire made from a shape memory alloy, which in the event of a change in temperature, for example by active heating using a heat source or inductive heating by an electrical voltage, generates relatively strong forces and brings about a change in position, for example of a lever, as an actuating element.

The domestic appliance according to the invention, or its closing device, comprises the RFID scanner that triggers the actuator. RFID is an abbreviation of “radio-frequency identification” and enables contactless communication between an RFID transponder and the RFID scanner. The RFID transponder has for example the shape of a credit card or is integrated in a key fob. The RFID transponder is preferably a passive RFID transponder. The RFID transponder may also be constructed as an NFC interface of for example a mobile terminal unit such as a smartphone.

Stored in the RFID transponder is a code that is associated with the closing device. As soon as the RFID transponder is in the active range of the RFID scanner, the latter can read the code in order then to trigger the actuator such that this latter, depending on the position of the closing device before the code was read, moves the closing device from its latched-shut position into its unlatched position or from its unlatched position into its latched-shut position. In this way, and automatically on the basis of the code that is read, the closed and latched-shut door leaf or the closed and latched-shut drawer is unlatched, or the closed but unlatched door leaf or the closed but unlatched drawer is latched shut.

In order to avoid the risk of wrong operation, according to a variant on the domestic appliance according to the invention the RFID scanner is constructed such that, at least for movement of the closing device from its unlatched position into its latched-shut position, it only triggers the actuator if the RFID scanner has read the code at least twice. Preferably, it may be provided for reading the code once to be sufficient to trigger the actuator for unlatching of the closing device, that is to say for movement of the closing device from its latched-shut position into its unlatched position, but for repeated reading of the code to be necessary to trigger the actuator for latching shut of the closing device, that is to say for movement of the closing device from its unlatched position into its latched-shut position.

In order to ensure that the closing device is only moved in the closed condition of the door leaf or the closed condition of the drawer, the domestic appliance according to the invention may have a door-open recognition device that is set up to recognize the open condition of the door leaf such that the RFID scanner only triggers the actuator when the door leaf is closed, or the domestic appliance according to the invention may have a drawer-open recognition device that is set up to recognize the open condition of the drawer such that the RFID scanner only triggers the actuator when the drawer is closed. The door-open recognition device or the drawer-open recognition device may for example communicate directly with the RFID scanner. In particular, the door-open recognition device or the drawer-open recognition device may be integrated in the closing device.

If the domestic appliance according to the invention has an electronic control device, the door-open recognition device or the drawer-open recognition device can also communicate with this electronic control device, which then transmits the required information to the RFID scanner. The door-open recognition device or the drawer-open recognition device can for example also be used for a further function of the domestic appliance. For example, the door-open recognition device may take the form of a light switch for opening of the door.

The RFID scanner and the actuator may for example be arranged in or on the base body.

So that the RFID scanner is able to communicate with the RFID transponder in order to read the code, the RFID transponder must be close enough to the RFID scanner. For improved communication between the RFID scanner and the RFID transponder, according to a preferred embodiment of the domestic appliance according to the invention the RFID scanner and the actuator are arranged in or on the door leaf or in or on the drawer.

If the domestic appliance according to the invention has the door leaf, the latter is in particular pivotally secured to the base body by means of hinges. In the lateral regions of the side of the base body that faces toward the door leaf, it is then possible to provide recesses that are provided for receiving and securing the hinges. Depending on the side on which the door leaf is secured to the base body, the hinges are either secured in the recesses provided on the left-hand side of the base body or in the recesses provided on the right-hand side of the base body. At least a part of the closing device can then be secured in one of the recesses in the base body in which no hinge is secured.

A conventional domestic refrigeration appliance can also be converted into a domestic appliance according to the invention for example by retrofitting the closing device.

According to a further embodiment of the domestic appliance according to the invention, it has a WLAN interface, that is to say an interface according to the WiFi standard. In this case, the domestic appliance may be set up to trigger the actuator on the basis of signals received by means of the WLAN interface such that the actuator moves the closing device from its latched-shut position into its unlatched position but the possibility that the actuator will move the closing device from its unlatched position into its latched-shut position on the basis of signals received from the WLAN interface is ruled out. Thus, if the domestic appliance receives an appropriate signal by means of its WLAN interface, for example from a device having a WLAN interface, the latched-shut door leaf or the latched-shut drawer is unlatched. The device is for example a mobile terminal unit such as a tablet computer or a smartphone. In particular, software, preferably an app, runs on the device and allows corresponding communication with the domestic appliance or its WLAN interface. However, it is not possible to latch the door leaf or the drawer shut by means of the WLAN interface. This ensures that the door leaf or the drawer is not inadvertently latched shut by means of the WLAN interface.

Exemplary embodiments of the invention are illustrated by way of example in the attached schematic drawings, in which:

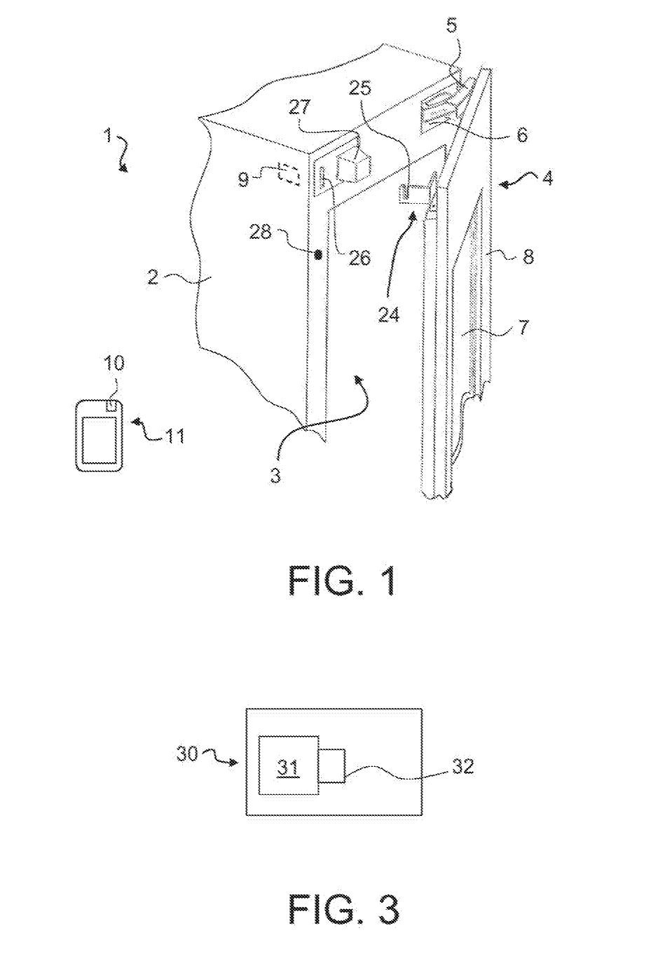

FIG. 1 shows part of a domestic refrigeration appliance in a perspective illustration,

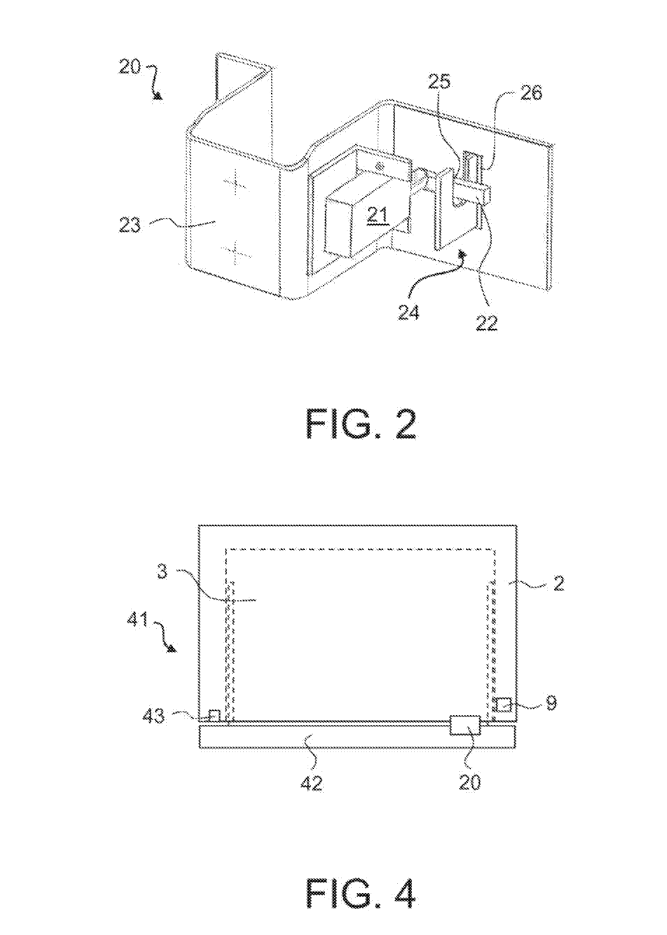

FIG. 2 shows a closing device of the domestic refrigeration appliance,

FIG. 3 shows an RFID transponder, and

FIG. 4 shows a further domestic refrigeration appliance.

FIG. 1 shows, in a perspective illustration, part of a domestic refrigeration appliance 1 as an example of a domestic appliance.

The domestic refrigeration appliance 1 has a body or housing 2 with a thermally insulated interior container that delimits an interior compartment 3 that may be cooled. The coolable interior compartment 3 is provided for storing refrigerated goods (not illustrated in more detail), in particular comestibles and/or non-food comestible items.

In the case of the present exemplary embodiment, the domestic refrigeration appliance 1 has a door leaf 4 that is mounted to pivot, for closing the coolable interior compartment 3. The door leaf 4 is mounted to pivot in particular in relation to a vertical axis (not illustrated). When the door leaf 4 is open, as illustrated in FIG. 1, the coolable interior compartment 3 is accessible.

The door leaf 4 is mounted to pivot in relation to the housing 2 by means of hinges 5. The hinges 5 are secured for example to the housing 2.

In the case of the present exemplary embodiment, the housing 2 has recesses 6 in the lateral regions of the side that faces toward the door leaf 4, and these recesses 6 are provided for receiving and securing the hinges 5. Depending on the side on which the door leaf 4 is fastened to the housing 2, the hinges 5 are either secured in the recesses 6 provided on the left-hand side of the housing 2 or in the recesses 6 provided on the right-hand side of the housing 2. In the case of the domestic refrigeration appliance 1 shown in FIG. 1, the hinges 5 are secured in the recesses 6 on the right-hand side of the housing 2.

The domestic refrigeration appliance 1 comprises a refrigeration device (not shown in more detail) for cooling the coolable interior compartment 3. The refrigeration device preferably takes the form of a refrigerant circuit that comprises in particular a compressor, a condenser downstream of the compressor, a throttle device which is downstream of the condenser and in particular takes the form of a constrictor tube or capillary tube, and an evaporator arranged between the constricting device and the compressor.

The domestic refrigeration appliance 1 further comprises an electronic control device (not shown in more detail) which is set up to trigger the refrigeration device, in particular the compressor, such that the coolable interior compartment 3 has at least approximately a predetermined target temperature.

The domestic refrigeration appliance 1 is for example a domestic chilling device and/or may take the form of a so-called No Frost domestic refrigeration appliance.

The domestic refrigeration appliance 1 is preferably a wine chill cabinet, which is provided for storing bottles filled with potable liquid, in particular wine. It is also possible to store non-food comestible items such as tobacco or tobacco products in the domestic refrigeration appliance 1.

In the case of the present exemplary embodiment, the door leaf 4 has at least one at least partly transparent pane 7 and a frame 8 that surrounds the pane 7 or panes 7. The pane 7 is preferably a glass pane, preferably a double-glazed pane. Because of the at least partly transparent pane 7, the wine bottles and/or non-food comestible items that are stored in the coolable interior compartment 3 may be viewed from outside when the door leaf 4 is closed. The frame 8 is preferably made at least partly from metal.

The domestic refrigeration appliance 1 further has a closing device 20, illustrated in more detail in FIG. 2, by means of which the closed door leaf 4 may be latched shut.

In the case of the present exemplary embodiment, at least part of the closing device 20 is secured in one of the recesses 6 in the housing 2 in which no hinge 5 is secured. In the case of the present exemplary embodiment, part of the closing device 20 is arranged in one of the recesses 6 on the left-hand side of the housing 2.

In the case of the present exemplary embodiment, the closing device 20 comprises an actuator 21 and a closing member 22 that is displaceable by means of the actuator 21. The actuator 21, which is for example an electric motor, can move the closing member 22 to and fro between a first position and a second position. In the case of the present exemplary embodiment, the actuator 21 is constructed to pivot the closing member 22 to and fro between the two positions. A linear movement of the closing member 22 is also possible, however.

Instead of an electric motor as the actuator 21, a solenoid which is able to move the closing member 22 to and fro between its two positions may for example be used as the actuator 21.

It is also possible for a wire made from a shape memory alloy to be used as the actuator 21, wherein the wire, in the event of a change in temperature, for example by active heating using a heat source or inductive heating by an electrical voltage, generates relatively strong forces and brings about a change in position, for example of a lever, as an actuating element.

The actuator 21 is connected in a manner fixed to the housing 2 and is preferably arranged in the corresponding recess 6. In the case of the present exemplary embodiment, the closing device 20 comprises an angle plate 23 that is secured to the housing 2 in particular by being screwed on. The actuator 21 is secured to the angle plate 23 for example by being screwed on.

In the case of the present exemplary embodiment, the closing device 20 comprises a further angle plate 24 that is secured to the door leaf 4, in particular on the side of the door leaf 4 that faces the housing 2. The further angle plate 24 comprises a region that projects away from the side facing the housing 2 and comprises a counter-closing member in the form of a hook 25. The region of the further angle plate 24 that comprises the hook 25 preferably projects at a right angle away from the side of the door leaf 3 that faces the housing 2.

The angle plate 23 that is secured to the housing 2 has a slot 26 through which the hook 25 protrudes into the corresponding recess 6 when the door leaf 4 is closed, as shown in FIG. 2.

The closing member 22 can now be moved by means of the actuator 21 such that, in its first position, shown in FIG. 2, it cooperates with the hook 25 such that the closing member 22 prevents the further angle plate 24 from being capable of being withdrawn from the slot 26 again by the opening of the door leaf 4. As a result, the closed door leaf 3 is latched shut by means of the closing device 20 when the closing member 22 is in its first position.

If the actuator 21 pivots the closing member 22 from the first position into the second position, the closing member 22 no longer cooperates with the hook 25. As a result, the closing device 20 allows the closed door leaf 3 to be opened. When the closing member 22 is in its second position, the closed door leaf 3 is unlatched.

In the second position, the closing member 22 is pivoted for example about an angle of 90° counterclockwise in relation to the first position.

The domestic refrigeration appliance 1 or the closing device 20 thereof further comprises an RFID scanner 27 that, in the case of the present exemplary embodiment, is secured to the angle plate 23 that is secured to the housing 2. The RFID scanner 27 is coupled to the actuator 21 and triggers the latter during operation of the domestic refrigeration appliance 1 so that the closing member 22 moves to and fro between its two positions. In this way, it becomes possible to latch the closed door leaf 3 shut and to unlatch it by way of the RFID scanner 27.

In the case of the present exemplary embodiment, it is provided for the RFID scanner 27 to be able to operate the actuator 21 only when the door leaf 4 is closed. In order to recognize the open condition of the door leaf 4, the domestic refrigeration appliance 1 comprises a door-open recognition device 28. This may be integrated for example in the closing device 20 and/or be directly connected to the RFID scanner 27. The door-open recognition device 28 may also be connected to the electronic control device of the domestic refrigeration appliance 1, however. In this case, the electronic control device may transmit information on the open condition of the door leaf 4 to the RFID scanner 27.

The RFID scanner 27 is able to communicate with an RFID transponder 30, which is shown in FIG. 3. The RFID transponder 30 is preferably a passive RFID transponder. The RFID transponder 30 has for example the shape of a credit card or is integrated in a key fob.

However, the RFID transponder 30 may also be an NFC interface, for example of a mobile terminal unit such as a smartphone.

The RFID transponder 30 comprises an integrated circuit 31 and an antenna 32 that is connected to the integrated circuit 31. Stored in the integrated circuit 31, or in a memory of the RFID transponder 30 that is connected to the integrated circuit 31, is a code that is associated with the closing device 20 and which the RFID scanner 27 is able to read as soon as the RFID transponder 30 is in the near field of the RFID scanner 27.

RFID transponders are known in principle to those skilled in the art and enable wireless communication with RFID scanners over a relatively short distance. If the RFID transponder 30 is close enough to the RFID scanner 27, the RFID scanner 27 can communicate in a manner known in principle to those skilled in the art and read the code that is stored in the RFID transponder 30 and associated with the closing device 20.

If the closed door leaf 3 is latched shut, that is to say if the closing member 22 is in its first position and the RFID transponder 30 has been brought close enough to the RFID scanner 27, then the RFID scanner 27 reads the code of the RFID transponder 30 and then triggers the actuator 21 such that the latter moves the closing member 22 from its first position into its second position, as a result of which the closed door leaf 4 is unlatched and so can be opened.

If the closed leaf door 4 is unlatched, that is to say if the closing member 22 is in its second position, and if the RFID transponder 30 is brought close enough to the RFID scanner 27, then the RFID scanner 27 reads the code of the RFID transponder 30 and then triggers the actuator 21 such that the latter moves the closing member 22 from its second position into its first position, as a result of which the closed door leaf 4 is latched shut and so can no longer be opened.

In order to avoid the risk of wrong operation, in the case of the present exemplary embodiment it is provided, for the purpose of latching shut, for the RFID scanner 27 to have to read the code of the RFID transponder 30 at least twice before the RFID scanner 27 triggers the actuator 21. For unlatching, by contrast, it is sufficient to read the code once.

In the case of the present exemplary embodiment, the actuator 21 is constructed such that it leaves the closing member 22 in its adopted position if the actuator 21 is not supplied with electrical power. As a result, the position of the actuator 21 is not changed in an undesirable manner in the event of a power failure.

In addition, the domestic refrigeration appliance 1 may have a WLAN interface 9, that is to say an interface according to the WiFi standard. The WLAN interface 9 may likewise trigger the actuator 21 if it receives an appropriate signal from a device having a WLAN interface 10, with the result that if the door leaf 4 is closed the actuator 21 moves the closing member 22 from the first position into the second position in order to unlatch the latched-shut door leaf 4. The device is for example a mobile terminal unit such as a tablet computer or a smartphone 11. In particular, software, preferably an app, runs on the device and allows corresponding communication with the domestic refrigeration appliance 1. However, it is not possible to latch the door leaf 4 shut by means of the WLAN interface 9, that is to say that the WLAN interface 9 is not set up to trigger the actuator 21 such that the latter moves the closing member 22 from the second position into the first position. This means that it is only possible to unlatch the closed door leaf 4 by way of the WLAN interface 9 but not to latch it shut.

Instead of the closing member 22 shown in FIGS. 1 and 2, which cooperates with the counter-closing member that takes the form of a hook 25, it is also possible to use other mechanical components. For example, secured to the door leaf 3 there may be a bolt as the counter-closing member, which in the closed condition of the door leaf 4 protrudes into an opening in the housing 2 or an opening in a component secured to the housing 2. The bolt may have a groove into which a closing member is bolted by a shear movement.

In the exemplary embodiment shown in FIG. 1, the RFID scanner 27 is connected in a manner fixed to the housing 2. As an alternative, it may also be provided for the RFID scanner 27 to be secured in or on the door leaf 4. In this case, the actuator 21, with the closing member 22, is preferably also secured in or on the door leaf 4 and the counter-closing member is secured in or on the housing 2.

FIG. 4 shows a plan view of a further domestic refrigeration appliance 41. Unless the description indicates otherwise, constituent parts of the domestic refrigeration appliance 41 shown in FIG. 4 that have substantially equivalent constructions and functions to constituent parts of the domestic refrigeration appliance 1 shown in FIG. 1 are provided with the same reference numerals.

The domestic refrigeration appliance 41 shown in FIG. 4 differs from the domestic refrigeration appliance 1 illustrated in FIG. 1 substantially in that it has no door leaf for opening and closing the coolable interior compartment 3, but rather has at least one drawer 42 that can be at least partly pulled out of the coolable interior compartment 3 in order to be loaded for example with comestibles and pushed into the coolable interior compartment 3 for storing the comestibles.

The domestic refrigeration appliance 41 shown in FIG. 4 likewise comprises the closing device 20, which is provided for the domestic refrigeration appliance 41 shown in FIG. 4, in order to latch shut and to unlatch the closed drawer 42, that is to say the drawer 42 that has been pushed into the coolable interior compartment 3.

So that the drawer 42 can be latched shut by means of the closing device 20 only when closed, the domestic refrigeration appliance 41 comprises a drawer-open recognition device 43 similar to the door-open recognition device 28 of the domestic refrigeration appliance 1 shown in FIG. 1, in order to recognize the open condition of the drawer 42.

It is also possible for the domestic refrigeration appliance 1 shown in FIG. 1 to comprise a further coolable interior compartment that is provided with a drawer and a closing device 20, corresponding to the drawer 42 of the domestic refrigeration appliance 41 shown in FIG. 4.

It is also possible for at least one drawer to be provided inside the coolable interior compartment 3 of the domestic refrigeration appliance 1, or at least one further door leaf which is provided for example in order to lock a part of the coolable interior compartment 3. This drawer or this further door leaf may likewise be provided with a corresponding closing device 20. If this drawer or the further door leaf is likewise to be lockable, it may be provided for actuation of the closing device 20 for the further door leaf or drawer to be initiated with a further RFID transponder on which a code is stored that differs from the code of the RFID transponder 30 shown in FIG. 3.

### LIST OF REFERENCE NUMERALS

1 Domestic refrigeration appliance

2 Housing

3 Coolable interior compartment

4 Door leaf

5 Hinge

6 Recess

7 Pane

8 Frame

9, 10 WLAN interface

11 Smartphone

20 Closing device

21 Actuator

22 Closing member

23, 24 Angle plate

25 Hook

26 Slot

27 RFID scanner

28 Door-open recognition device

30 RFID transponder

31 Integrated circuit

32 Antenna

41 Domestic refrigeration appliance

42 Drawer

43 Drawer-open recognition device

1-10 (canceled).

11. A domestic appliance, comprising:
a base body having an interior compartment;
a door leaf being pivotable relative to said base body for opening and closing said interior compartment; and
a closing device, said closing device having an actuator for moving said closing device back and forth between a position latching said closed door leaf and a position unlatching said closed door leaf, and said closing device having an RFID scanner;
said RFID scanner being configured to read a code stored in an RFID transponder and associated with said closing device, for triggering said actuator to move said closing device, depending on said position of said closing device before reading the code, from said latching position into said unlatching position or from said unlatching position into said latching position.

12. The domestic appliance according to claim 11, which further comprises a door-open recognition device configured to recognize an open condition of said door leaf and to permit said RFID scanner to trigger said actuator only when said door leaf is closed.

13. The domestic appliance according to claim 1, wherein said RFID scanner and said actuator are disposed in or on said door leaf.

14. A domestic appliance, comprising:
a base body delimiting an interior compartment;
a drawer configured to be at least partly pulled out of said interior compartment and pushed into said interior compartment; and
a closing device, said closing device having an actuator for moving said closing device back and forth between a position latching said closed drawer and a position unlatching said closed drawer, and said closing device having an RFID scanner;
said RFID scanner being configured to read a code stored in an RFID transponder and associated with said closing device, for triggering said actuator to move said closing device, depending on said position of said closing device before reading the code, from said latching position into said unlatching position or from said unlatching position into said latching position.

15. The domestic appliance according to claim 4, which further comprises a drawer-open recognition device configured to recognize an open condition of said drawer and to permit said RFID scanner to trigger said actuator only when said drawer is closed.

16. The domestic appliance according to claim 4, wherein said RFID scanner and said actuator are disposed in or on said drawer.

17. The domestic appliance according to claim 11, wherein said RFID scanner only triggers said actuator if said RFID scanner has read the code at least twice, at least for movement of said closing device from said unlatching position into said latching position.

18. The domestic appliance according to claim 14, wherein said RFID scanner only triggers said actuator if said RFID scanner has read the code at least twice, at least for movement of said closing device from said unlatching position into said latching position.

19. The domestic appliance according to claim 11, wherein said closing device remains in said unlatching position after said closing device has been moved into said unlatching position, and said closing device remains in said latching position after said closing device has been moved into said latching position.

20. The domestic appliance according to claim 14, wherein said closing device remains in said unlatching position after said closing device has been moved into said unlatching position, and said closing device remains in said latching position after said closing device has been moved into said latching position.

21. The domestic appliance according to claim 11, which further comprises:
a WLAN interface;
said actuator being triggered on a basis of signals received by said WLAN interface causing said actuator to move said closing device from said latching position into said unlatching position,
but said actuator being prevented from moving said closing device from said unlatching position into said latching position on a basis of signals received from said WLAN interface.

22. The domestic appliance according to claim 14, which further comprises:
a WLAN interface;
said actuator being triggered on a basis of signals received by said WLAN interface causing said actuator to move said closing device from said latching position into said unlatching position,
but said actuator being prevented from moving said closing device from said unlatching position into said latching position on a basis of signals received from said WLAN interface.

23. The domestic appliance according to claim 11, wherein:
the domestic appliance is a domestic refrigeration appliance; and
said base body is a thermally insulated housing having a refrigeration device for cooling said interior compartment.

24. The domestic appliance according to claim 14, wherein:
the domestic appliance is a domestic refrigeration appliance; and
said base body is a thermally insulated housing having a refrigeration device for cooling said interior compartment.

25. The domestic appliance according to claim 23, wherein said interior compartment is provided for storing at least one of wine or non-food comestible items.

26. The domestic appliance according to claim 24, wherein said interior compartment is provided for storing at least one of wine or non-food comestible items.
